(19) United States
(12) Patent Application Publication
(10) Pub. No.: US 2025/0259126 A1
(43) Pub. Date: Aug. 14, 2025

(54) WORK AND PRIVATE LIFE MANAGEMENT SYSTEM AND METHOD

(71) Applicant: Dilek METE, Istanbul (TR)

(72) Inventor: Dilek METE, Istanbul (TR)

(21) Appl. No.: 18/702,432

(22) PCT Filed: Jan. 24, 2022
(86) PCT No.: PCT/TR2022/050054

§ 371 Date: Apr. 18, 2024

(30) Foreign Application Priority Data
Oct. 25, 2021 (TR) 2021/016598

(51) Int. Cl. G06Q 10/0637; G06Q 10/0639

(52) U.S. Cl. CPC G06Q 10/0637; G06Q 10/06393; G06Q 10/06398

(57) ABSTRACT

A work and private life management system that enables individuals to manage their work and private lives in a balanced manner, including a work/career/profession goal module that enables users to create their work/career/profession profiles and/or private/personal profiles, that enables the determination of the criteria for goal and success related to their work and career, a private/personal goal module that enables the determination of the criteria for goal and success related to their private and personal life, a work/career/profession action module that enables the determination and management of actions related to their work and career, a private/personal action module that enables the determination and management of actions related to their private and personal life, a structured feedback module that can be reported separately according to their work and private life profiles, a database that enables the collection of all data collected from the users, and a mobile device.

### TECHNICAL FIELD

The invention relates to a model that will solve the problem of Work and Life Balance, which is one of the important problems of individuals (people, employees, professionals, leaders), and the work and private life management system and method consisting of mobile and web application developed based on this model.

### STATE OF THE ART

The most important problem of an individual or company that has set itself a goal is to ensure the belief and support of other people/employees. Many training, approaches, and efforts are made to achieve this. However, it is very difficult to get the support of other people within the scope of their desire to be involved, and to reveal this as clear results, feedback, and dissemination. In particular, there is no model and system that deals with this in terms of work and private life balance.

An important problem of institutions, managers and people who want to progress in professional work life is the ability to measure the operational and strategic contribution to the goal with a fair work-duty-responsibility sharing, to receive instant, healthy, and objective feedback and to turn it into concrete values. Similarly, it is important for a happy life that the responsibilities we take in our private life are shared and that this sharing can be followed, and that it is fair between family and friends. On the other hand, it reveals the necessity of following up the works remotely and in digital environments especially in the remote working that started with the pandemic, and requires people to follow their own works and the works they work with instantaneously. All of these push people to look for a model, platform and system where they can follow the work, see their easy and instantaneous progress and get feedback.

The summary of the application numbered 2018/19590, which emerged as a result of technical research, is as follows; “This invention is related to a system that aims to increase employee satisfaction in corporate companies and enables employees to convey their thanks and appreciation to each other and to win awards in the blockchain structure in line with the thanks and appreciation they conveyed and received.”

The system relates to a system that provides thanking and rewarding among the employees of the institution, and it mentions a system that can provide a solution to the disadvantages mentioned above and a system that protects the work-private life balance.

In conclusion, it was deemed necessary to make an improvement in the relevant technical field due to the disadvantages described above and the inadequacy of the existing solutions on the subject.

### THE OBJECT OF THE INVENTION

The invention aims to provide a structure having different technical features that are novel in this field, different from the embodiments used in the state of art.

The primary object of the invention is to provide a system and method that supports individuals to create a happier life, more enthusiastic members of teams (individuals or institutions gathered for a purpose) and a balanced culture, by focusing on the goals that individuals want to achieve, and to manage their responsibilities and relationships for these goals by considering the work and private life balance.

The object of the invention is to present a system and method that enables individuals to determine the goal they want to focus on in their private life, and to balance their relationships and responsibilities by sharing tasks and receiving feedback with their family, friends or people they want to participate in.

An objective of the invention is to enable the leaders to focus the team members and employees on the goal they want to focus on, to get their contributions, to share their responsibilities fairly and clearly, to create synergies, to develop collective intelligence, to receive and give feedback and to better identify each other with the inventories and to balance their relationships.

Some of the benefits of the system of the invention are as follows;
Creating work and private profiles of users on a single platform, managing, reporting and sharing them at the same time without interfering with each other while protecting privacy,
Using a goal system known as OKR (Objective and Key Results) in Criteria for Work/Career Goals and Success,
Creating a system where OKR is used for private life on an individual basis and followed and shared on the same platform with work goals,
Creating a hierarchy with unlimited flexibility of the spread of individual goals and managing it on a single system for work and private life,
Creating goal-dependent actions (Project management is a rare feature in performance management systems. It is usually used for planning purposes.)
Planning and managing the actions by linking the goals and actions with each other, focusing on the goal and separating the actions to achieve this focus for work and private life,
Giving and receiving feedback on the basis of determined competencies in order to be evaluated perceptually by the stakeholders around the person,
Immediately measuring the perception of all connected persons about the completed work when the goal or action is completed,
Using emoji or conceptual designs for feedback purposes,
Institutions using inventory and tests to get to know the employees more closely on the recruitment, career and education side,
Ensuring the collection of all kinds of data with a questionnaire and form design tool similar to the Google Forms structure,
Connecting the created forms to each other with a key data definition (which can consist of number and/or word groups) and creating a database consisting of form titles and analyzing this database by the user and/or institution through the portal,
Using gamification methods to ensure the commitment and motivation of people,
The tools widely used in work life and generally reported only to HR or management units being used to better know relatives such as family and friends in private life and both work and private profile reports being given to the person in order to balance the work and private relationship,
In work and private life, providing people with the opportunities such as following, to see and manage the return of their time investment in their work and private lives in many other scales:
   Level of focus on goal (number of focused actions and work/private life ratio),
   Level of contribution to own goal (each created goal, action, and their work/private life ratio),
   Level of contribution of others (the level of contribution of others to the goals and actions of the person),
   Level of contribution to others (The level of accepting the goals and actions shared with the person and contributing by adding new actions or goals),
   Level of sharing (including others in their goals, receiving and giving support),
   Ratio of effort periods allocated for work and private life,
   Ratio of completion of goals and actions in work and private life,
   Speed of completing the goals and actions in work and private life,
   Suggestions for your character fit and better relationships with the people you work with,
   Completed works and the points you have earned from the requested feedback,
   Meaning and usage rates of gestures that support certain competencies, values, and emotions in communication and messaging,
   Work and private life reports of structured or explicit feedbacks.

An invention comprising a work and private life management system that enables individuals to manage their work and private lives in a balanced manner in order to achieve the objects described above, characterized by comprising:
The following modules that enable users to create their work/career profiles and/or private/personal profiles;
   the work/career/profession goal module that enables the determination of the criteria for goal and success related to the work and career,
   a private/personal goal module that enables the determination of the criteria for goal and success related to private and personal life,
   The work/career/profession action module that enables the determination and management of the actions related to the work and career,
   private/personal action module that enables the identification and management of actions related to private and personal life,
a work and private life management application that operates on a computer/mobile device and comprising a database that keeps all data collected from users.

The structural and characteristic features and all the advantages of the invention will be understood more clearly by means of the figures and the detailed description with reference to these figures given below and therefore, the evaluation should be made by taking these figures and the detailed description into consideration.

### FIGURES TO HELP UNDERSTAND THE INVENTION

FIG. 1 is the representative illustration of the system according to the invention.

The drawings are not necessarily drawn to scale and details which are not necessary for the understanding of the present invention may be omitted. In addition, elements that are substantially identical or have substantially identical functions are denoted by the same reference signs.

### List of the Reference Numbers

10. Work and private life management application
11. Work/Career/profession profile
111. Work/career/profession goal module
112. Work/career/profession action module
113. Work/career/profession data
12. Private/personal profile
121. Private/personal goal module
122. Private/personal action module
123. Private/personal data
13. Relation unit
20. Database
30. Computer/mobile device
HB. Criteria for goal and success
AK. Action
AK1. Action 1
AK2. Action 2
AK3. Action 3
FO. Form
F. Private/personal support action
G. Private/personal action approval
H. Work/career/profession support action
I. Work/career/profession action approval
J. Feedback
K. Recognition/Appreciation
L. Contact
Z. Private/Personal reporting parameters
Y. Work/Career/profession reporting parameters
GR. Feedback module
AL. Alev
AY. Ayşe
DE. Demet
DI. Dilek
LA. Lale
MA. Masal
ME. Mert
MI. Misra
MU. Murat
SE. Sevgi
UM. Umut
VE. Veli

### DETAILED DESCRIPTION OF THE INVENTION

In this detailed description, the preferred embodiments of the invention are merely described for a better understanding of the subject matter and without any limiting effect.

It relates to the work and private life management system and method consisting of work and private life management application (10) working on Computer/Mobile device (30) according to a model that solves the problem of Work and Life Balance, which is one of the important problems of individuals (people, employees, professionals, leaders).

Users log in to the work and private life management application (10), which is the subject of the invention, and create their account with their phone number. Users can create their private/personal profile (12) by entering their work/career/profession profile (11) and private e-mail address by entering their work e-mail address. The Work/Career/profession profile (11) is represented by the bag icon and the Private/Personal profile (12) by the heart icon (These icons can be changed optionally).

The user creates a goal or action by selecting the work/career goal module (111), work/career/profession action module (112), private/personal goal module (121) or private/personal action module (122) according to the icons. It determines the criteria for goal and success (HB) by creating goals in goal modules (111, 121). It can also connect the actions depending on the success criteria to the action modules (112, 122) by creating them without leaving the relevant profile (11, 12). They can choose the people they want to see the goal. If an organization uses the system, if the organizational chart is defined, the affiliated employees of the leaders can automatically see the goals of the leaders. People who see their goal as observers can create their own criteria for goals and success (HB) depending on this goal if they want. If criteria for goal and success (HB) are created depending on another person's criteria for goal and success (HB), this goal is now one of your focuses to support. As all the actions (AK) you create or accept and connect to this goal are completed, the goal you connect to progresses. If the user wishes, they can create a direct action (AK) and assign it to other people without entering criteria for goal and success (HB) or they can create and follow their own actions (AK).

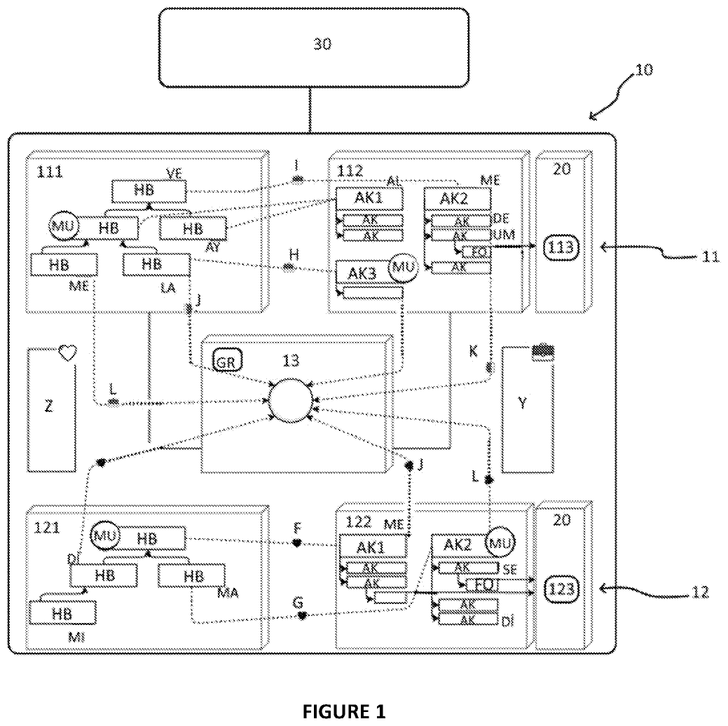

Actions (AK) connected to criteria for goal and success (HB) are subject to the approval of the people. The letter I in FIG. 1 shows work/career/profession action approval. Some sample names are given to better understand the system from there. For example, an action is shown in which Mert (ME) is responsible depending on the Criteria for Top Goal and Success (HB) of Veli (VE) here. Mert (ME) shared this responsibility with Demet (DE) and Umut (UM) in the sub-actions. Veli (VE) may have created the action and assigned it to Mert (ME). Mert (ME) may have created the action (AK) and connected the top goal since the top goal was shown to him. Mert (ME) may have added Demet (DE) and Umut (UM) as observers to the Action 2 (AK2) he was responsible for. Demet (DE) and Umut (UM) may have willingly formed the sub-actions (AK). Or, Mert (ME) may have made all the assignments and Demet (DE) and Umut (UM) may have accepted them on the contrary.

The letter H in FIG. 1 represents work/career support action (H). The main user here, Murat (MU), may have opened an action (AK) to support Jale (JA), who creates a goal based on her work/career/profession goal, or Jale (JA) may have requested it from Murat (MU).

When Murat (MU) completes Action 3 (AK3), the request for feedback falls to Jale (JA) and himself, who is the supervisor, since he is not responsible for any other actions in the relation unit (13). Participation is provided in the feedback process in the form of competence icons, points, open text ideas or emotions. Reports in the relation unit (13) may be explicit according to the people's sharing permissions. If sharing permissions are closed, they are reported anonymously in cases of 5 people and above. Work/career reporting parameters (Y) and Private/Personal reporting parameters (Z) can be shown as Focus, Contribution, Sharing, Effort, Completion, Speed, Character, Score, Gesture, Feedback.

The letter L in FIG. 1 shows communication (L). Here, Mert (ME) determined the Criteria for Goal and Success (HB) for himself. He can see how it is perceived by others through goal-dependent weekly and monthly evaluation or feedback, communication or appreciation/recognition icons used in correspondence with observers even though no action (AK) appears.

The letter K in FIG. 1 shows Recognition/Appreciation (K). Dilek (DI) needs the completion of the goal of Misra (MI) in order to complete her own goal. Murat (MU) is the observer here. Dilek (DI) and Murat (MU) send recognition/appreciation (K) with a gesture of gratitude, score or emotion for Misra (MI), who supports the goal when the goal of Dilek (DI) is completed.

Murat (MU) needs to complete Action 2 (AK2) in a private/personal scale in order for Masal (MA) to complete its goal.

The letter F in FIG. 1 represents Private/personal support action (F). Normally, Murat (MU) and Mert (ME), who work together and have a connected goal on the work/career/profession side, also meet in a private/personal scale and Mert (ME) support the personal goal of Murat (MU) with Action 1 (AK1).

The letters K, L, and J in FIG. 1 show the flow of feedback, communication, and appreciation/recognition in work/career and private/personal scales. All kinds of feedback, communication and appreciation/recognition within goals and actions turn into a measure and enable the person to see their own perception.

The database (20) is the place where the data in the system is collected and classified. The data collected by means of forms that can be added to the actions (AK) are transferred to the database (20). The straight arrows showing the data flow show the data flow collected through the forms added to the actions in FIG. 1. This data can be a customer form or a questionnaire in the work/career scale. The forms can be connected to each other as a process with the key data definition defined in the forms. For example, a form connected to the sub-action in the work/career/profession action module (112) may be the result form of the customer introduction meeting in the customer acquisition process. The key data may be the customer number in this case. 5 different forms completed by different persons responsible in different actions, connected to each other by customer number, can be analyzed. The data collected by means of all forms such as customer information form, customer profile form, problem detection form, promotional organization form, customer introduction meeting result form etc. are transferred to the database (20). Private/personal action module (122) is the same as the form structure mentioned above, connected to the sub-actions. For example, it can be a shopping or needs list or activity checklist. Thus, Murat (MU) can see the data of all needs arising from the information entered in the same form in different actions with this form as a single list and turn it into a new action and/or classify what needs to be taken as type, store, department. The data obtained with these forms are also collected in the database (20).

The objectivity of the perceptions of the people and their different levels in different people are reported by the system according to Private/Personal reporting parameters (Z) and Work/Career reporting parameters (Y) since the whole process flows through the completed networks.

The process steps performed by the system of the invention are as follows;
Logging in to work and private life management application (10) and creating an account by the user via computer/mobile device (30),
Creating private/personal profile (12) by entering private e-mail address and creating work/career profile (11) by entering work e-mail address by the user,
Selecting the work/career/profession goal module (111), work/career/profession action module (112), private/personal goal module (121) and/or private/personal action module (122) by the user,
Defining the Criteria for Goal and Success (HB) in the goal modules (111, 121) by the user and sharing it with other people who are desired to be seen, creating their own connected criteria for goal and success (HB) by selecting this goal focus if they want to include/support the people who see the goal (observer), (Thus, as the success criteria of the connected goals are realized, the top goal (according to the weight and importance rates) progresses) (“Top Goal” is the definition that is focused, desired, imagined, desired to be made at the top of the goal hierarchy. Learning English in an individual scale, getting into university, losing weight or removing a team/institution size product as imagined, such as reaching the desired position in the industry.) (“Success Criteria” is like an indication of a navigation that shows the location, distance, and different routes to the destination. It is defined by clear indicators such as numbers and dates. Achievement of the success criteria means that the goal is achieved.) (Only one person is responsible for each focus defined as “Criteria for Goal and Success (HB)”. Thus, responsibilities become clearer, people determine their own goals with willingness.) (“Criteria for Goal and Success (HB)” may be determined monthly, quarterly, semi-annually and annually as well as according to the characteristics of each goal. Each week, the evaluation of the past and what needs to be done to achieve the goal are entered into the system and commitment, focus and planning are ensured.)
Updating the success criteria in each progress and sending notifications for review, update and re-approval of all linked Criteria for Goal and Success (The update takes place, especially if there are other opportunities in their ambiguous environment, if there are changes. If completely different conditions occur, it is canceled and a new one is determined. These changes affect the hierarchy horizontally and vertically.)
Creating actions (AK) by the users to reach the criteria for goal and success (HB) or independently of them,
   Individuals who are added as observers to a goal focus or action (AK) are voluntarily involved in the process by forming an action (AK) or action (AK) sub-action, or by assigning an action (AK) to another person and involving others in the process, (Action and sub-action managers are only responsible for their own scale of their work. They can access reports on the basis of speed, completion and feedback in all actions and/or sub actions they are responsible for.) (Each action (AK) has only one person responsible, the person who does the work. This person can divide the action (AK) into sub-action, assign people to sub-action, or only add the people they want to see the progress of the work to the system as observers)
   Requesting approval for the assigned actions (AK) and accepting or rejecting the assigned person action (AK), following up the rejection reason or approval status with notifications,
   Communicating with each step in the ongoing actions through messaging and seeing the messages in the actions only by persons responsible and observers assigned to the action, (Emojis and gestures added in messaging are defined according to predefined feelings, thoughts and character types. It is kept in the system as feedback within the scope of the communication given and received by the person according to these definitions/meanings and can be reported on the basis of connected goal focus or action, according to private life and work balance.)
Completing the actions (AK) and success criteria in a timely manner and giving points to all persons who have taken responsibility for the goal or action in proportion to their contributions by the system,
If the goal is reached successfully, the whole team should be instantly appreciated with points, recognition/appreciation and one-to-one feedback, and the goal should be completed and recognized and communicated to the top goal owner and all persons responsible and observers within the goal spread (Users should use the score, gestures, emojis, etc. given to be distributed to them within the given time.)
Persons responsible requesting feedback from the observers and other persons responsible for themselves in each defined goal focus and action (AK), (These feedbacks are only reported to the person who wants it as emotion and perception.)
If the user sends a request for recognition if they want to know themselves or the people they are responsible for within the scope of the same goal focus or action (AK) in terms of private and work character, if the request is approved, completing the inventory and tests related to the character profile, (When both parties complete the inventory and tests, their own reports and the report of the people they want to know are shared by the mutual system.)
Adding the features of profile strengths such as competence, ability, motivation area, value, emotion, skill, interest, expertise to work/career/profession and private/personal profiles (11, 12) by the user with their designed visuals and explanations,
As long as the profile powers are approved by other users, adding them to the profile with the name of superpowers is recommended by the system (if the user allows) as a suggestion when searching for expertise, talent, etc. for an action. These superpowers differ in their work/career/profession and private/personal profiles. The person can see in which area they are perceived differently.)
The objectivity of the perceptions of the people, different perception levels in different people being reported by the system to the users with all feedback, communication and appreciation/recognition being received through clear actions, (Triggering an evaluation in the feedback module (GR) for each completed Criteria for Goal and Success (HB) and Action (AK), Collecting opinions with development-oriented questions by sending them to all persons responsible and observers, Sending suggestions for a better result, thanks score and profile power approval (competence-based), determining the level of meeting the expectations of the person who gave the feedback (J) for the Criteria for Goal and Success (HB) or Action (AK) completed within the scope of feedback (J) and determining the perception of the person's work results by reporting all direct or indirect feedback (J), Occupational inventories, professional ability tests, professional interest inventories, professional knowledge and skill evaluations for the work/career scale, and personality inventories, hobbies, motivation areas, personal interests in the private/personal scale.)
Collecting and/or surveying data by creating a form on work and private life management application (10) and transferring the collected data to the database (20), (Forms can be defined by a flexible form creation tool (text, date, document, question, etc.).
   Connecting the forms with the key data definition (customer number, project name, goal name, shopping list name, house expenses, house cleaning questionnaire, etc.) in the definition,
   Collecting data with one or more forms that can be connected to action and/or sub-action, creating their own work process or applying their own questionnaires, (Forms that are connected to action and/or sub-action can also be connected to each other with key data.)
   Sharing the data of the database (20) according to separate sharing rules according to its work and private nature,
      Sharing the data with the desired persons privately, (For example, shopping lists created with the form can be analyzed according to date, product group, frequency of needs, etc.)
      The data generated on the work side should only be shared with people within the same organization (accounts created with similar domains), (The relevant institution must give permission in order to share with a person outside the organization. The persons authorized by the same institution and the user can access the data and perform analyzes or can see the analyses made.)

1. A work and private life management system that enables individuals to manage their work and private lives in a balanced manner, comprising a work and private life management application that operates on a computer/mobile device wherein:
the work and private life balance management application enables users to create and independently manage their work/career/profession profiles and/or private/personal profiles within the same platform and application;
the work and private life management application comprising a database that keeps all data collected from users and having:
a work/career/profession goal module that enables the determination of the criteria for goal and success related to the work and career;
a private/personal goal module that enables the determination of the criteria for goal and success related to private and personal life;
a work/career/profession action module that enables the determination and management of the actions related to the work and career;
a private/personal action module that enables the identification and management of actions related to private and personal life; and
a management of personal perception and relationships module with the reporting of feedback related to private and personal life and work and career separately or together from the feedback module.

2. The work and private life management system in accordance with claim 1, wherein the work and private life management application enables the defined Criteria for Goal and Success to be shared with other people who are desired to be seen, and enables the people who see the goal to create their own connected criteria for goal and success by selecting this goal focus if they want to be included/supported.

3. The work and private life management system in accordance with claim 1, wherein the work and private life management application enables the success criteria to be updated in each progress and sends notifications for the review, update and re-approval of all linked Criteria for Goal and Success.

4. The work and private life management system in accordance with claim 1, wherein the work and private life management application enables the request of approval for the assigned actions and the follow-up of the acceptance or rejection of the assigned person action with notifications.

5. The work and private life management system in accordance with claim 1, wherein the work and private life management application enables communication in each step through messaging in ongoing actions and that enables only persons responsible, and observers assigned to the action to see the messages in the actions.

6. The work and private life management system in accordance with claim 1, wherein the work and private life management application enables the completion of the actions (AK) and success criteria in a timely manner and the awarding of points to all persons who have taken responsibility for the goal or action in proportion to their contributions.

7. The work and private life management system in accordance with claim 1, wherein the work and private life management application enables the whole team to be instantly appreciated with points, recognition/appreciation and one-to-one feedback if the goal is reached successfully, and to be communicated to the top goal owner and all persons responsible and observers within the goal spread.

8. The work and private life management system in accordance with claim 1, wherein the work and private life management application enables the user to send a request for recognition if they want to know themselves or the people they are responsible for within the scope of the same goal focus or action in terms of private and work character.

9. The work and private life management system in accordance with claim 1, wherein the work and private life management application enables the user to add the features such as competence, ability, motivation area, value, emotion, skill, interest, expertise to their work/career/profession and private/personal profiles with designed images and explanations.

10. The work and private life management system in accordance with claim 1, wherein the work and private life management application enables the collection and/or survey of data and the transfer of the collected data to the database.

11. A work and private life management method that enables individuals to manage their work and private lives in a balanced manner, comprising the following steps:
logging in to a work and private life management application and creating an account by the user via a computer/mobile device;
creating a private/personal profile by entering private e-mail address, creating work/career/profession profile by entering work e-mail address by the user;
selecting a work/career/profession goal module, work/career/profession action module, private/personal goal module and/or private/personal action module by the user;
defining a Criteria for Goal and Success in the goal modules by the user and creating their own connected criteria for goal and success if they want to include/support the people who see the goal;
updating the success criteria in each progress and sending notifications for review, update and re-approval of all linked Criteria for Goal and Success;
creating actions by the users to reach the criteria for goal and success or independently of them;
the objectivity of the perceptions of the people, different perception levels in different people being reported by the system to the people who want with all feedback, communication and appreciation/recognition being received through clear actions;
collecting and/or surveying data by creating a form on work and private life management application and transferring the collected data to the database.

12. (canceled)

13. The work and private life management method in accordance with claim 11, comprising the steps of requesting approval for the assigned actions and accepting or rejecting the assigned person action, and following up the rejection reason or approval status with notifications.

14. (canceled)

15. The work and private life management method according to claim 11, comprising the following steps:
connecting the forms with the key data definition in the definition;
collecting data with one or more forms that can be connected to action and/or sub-action, creating their own work process or applying their own questionnaires;
sharing the data of the database according to separate sharing rules according to its work and private nature;
sharing the data with everyone requested privately; and
sharing the data generated on the work side only with people within the same organization.

16. The work and private life management method in accordance with claim 11, comprising the step of completing the actions and success criteria in a timely manner and giving points to all persons who have taken responsibility for the goal or action in proportion to their contributions.

17. The work and private life management method in accordance with claim 11, comprising the steps of instantly appreciating the whole team with points, recognition/appreciation and one-to-one feedback if the goal is reached successfully or act role model, communicating the goal to the top goal owner and all persons responsible and observers within the goal spread.

18. The work and private life management method according to claim 11, comprising the step of requesting feedback from the observers and other persons responsible in each defined goal focus and action.

19. The work and private life management method according to claim 11, comprising following steps: triggering an assessment in the feedback module for each completed Criteria for Goal and Success and Action, collecting opinions with development-oriented questions by sending them to all persons responsible and observers, sending suggestions for a better result, thanks score and profile power approval (competence-based), determining the level of meeting the expectations of the person who gave the feedback for the Criteria for Goal and Success or Action completed within the scope of feedback and determining the perception of the person's work results by reporting all direct or indirect feedback, occupational inventories, professional ability tests, professional interest inventories, professional knowledge and skill evaluations for the work/career/profession scale, personality inventories, hobbies, motivation areas, personal interests in the private/personal scale.

20. The work and private life management method in accordance with claim 11, comprising the steps of completing the inventory and tests related to the character profile if the user sends a request for recognition if they want to know themselves or the people they are responsible for within the scope of the same goal focus or action in terms of private and work character.

21. The work and private life management method in accordance with claim 11, comprising the following steps: adding the features of profile strengths such as competence, ability, motivation area, value, emotion, skill, interest, expertise to work/career and private/personal profiles by the user with their designed visuals and explanations.

22. The work and private life management method according to claim 11, comprising the steps of adding the approval of profile powers by other users to the profile.
